(19) United States
(12) Patent Application Publication
(10) Pub. No.: US 2021/0004682 A1
(43) Pub. Date: Jan. 7, 2021

(54) ADAPTING A SEQUENCE MODEL FOR USE IN PREDICTING FUTURE DEVICE INTERACTIONS WITH A COMPUTING SYSTEM

(71) Applicant: Google LLC, Mountain View, CA (US)

(72) Inventors: Xiaohong Gong, Mountain View, CA (US); Tyler Brabham, Mountain View, CA (US); Chia-yueh Chu, London (GB)

(21) Appl. No.: 16/978,653

(22) PCT Filed: Jun. 27, 2018
(86) PCT No.: PCT/US2018/039845

§ 371 Date: Sep. 4, 2020

(51) Int. Cl. G06N 3/08; G06F 9/451

(52) U.S. Cl. CPC G06N 3/08; G06F 9/451

(57) ABSTRACT

A system is described that relies on a sequence model, having been trained using features extracted from contextual information of a computing device, to determine characteristics of past user interactions that resulted in conversions of items from a computing system. Once trained, the sequence model generates a sequence output that is indicative of characteristics of future user interactions that will result in a future conversion of an item from the computing system. An existing prediction model of the system, having been further trained using the output from the sequence model, identifies a future context during which the future user interactions with the computing system will result in the future conversion. In response to recognizing the future context, the system outputs an indication of the item to facilitate the future conversion.

### BACKGROUND

Some computing systems try to predict information to output to a user, at just the right time or context. For example, some computing systems may determine, based on previously observed user interactions with an application provider service (e.g., an application store), which applications in a prediction space that a user may want to download to a device and, in some examples, automatically rank those applications higher when the user searches for new applications.

Often, a bag-of-words (BoW) model is used by a computing system to perform predictions based on historical observations within a prediction space. Even though a BoW model can be simpler to implement than other types of models, a drawback may be that a BoW model treats all features of items in a prediction space equally, despite the fact that some features may be more or less useful than others for use in making predictions. As a result, some prediction models may be less accurate and contribute to user frustration with, or lack of adoption of, a computing system.

### SUMMARY

In general techniques of this disclosure are directed to using sequence models to account for historical differences of user behavior with a computing system, as a way to better predict future behaviors with the computing system. As one example, a computing system may, overtime, extract various temporal or sequential features of user interactions with an application provider service, such as an application store, market, database, or the like. The computing system may train one or more recurrent neural networks (RNNs), long-short-term-memory (LSTM) models, attention models, or other type of sequence models using the extracted temporal or sequential features to capture a user's past history and interest and identify application recommendations that are more likely to result in conversions (e.g., actual downloads or consumptions of particular applications) from the applications provider service. Based in part on the output from the sequence model, a prediction or ranking model (e.g., a deep-learning-neural-network (DNN)) of the computing system may rank, recommend, or otherwise present recommended applications from the application provider service. In this way, the described techniques may enable existing prediction or ranking systems to account for changes in interests and characteristics in user behavior, in a similar way that these existing systems already account for other predictive signals.

By enabling systems to easily account for changes in user behavior and interest, over time, the described techniques may improve the accuracy of prediction or ranking systems, without requiring much if any re-engineering of an existing prediction model, to account for such differences. That is, an existing prediction or ranking system may already rely on other types of feature embeddings to identify items in a prediction space. In a similar way, these existing systems can easily be reconfigured to also rely on the output of a sequence model (i.e., a sequence output) that is indicative of the temporal or sequential aspects of user behavior with the system. Accordingly, an example computing system may perform better, operate more efficiently, and perhaps result in a more useful user experience as compared to other systems.

That is, using sequence models, such as LSTM models, RNN models, attention models, or other types of sequence models, in accordance with the described techniques, to enhance an existing prediction model with temporal or sequential behavioral predictions, may enable the existing prediction model to have a better query time efficiency (i.e., fewer operations performed by a model to obtain a result thereby resulting in a shorter time delay to return a prediction) than was previously possible without use of the described techniques. The example computing system may therefore minimize frustrations users may otherwise experience from interactions with a less accurate or slower prediction or ranking system.

Throughout the disclosure, examples are described where a computing device and/or computing system may analyze information (e.g., contextual information, user and/or device interaction data, etc.). However, the system may only use the information after the computing device and/or the computing system receives explicit permission from a user of the computing device and/or the computing system. For example, in situations discussed below in which the computing device and/or computing system may collect information about user interactions with applications executing at computing devices or computing systems, individual users may be provided with an opportunity to provide input to control whether programs or features of the computing device and/or computing system can collect and make use of the information. The individual users may further be provided with an opportunity to control what the programs or features can or cannot do with the information.

In addition, information collected may be pre-treated in one or more ways before it is transferred, stored, or otherwise used by a computing device and/or computing system, so that personally-identifiable information is removed. For example, before an example computing system stores user interaction data associated with an application executing at a computing device, the example computing system may pre-treat the data to ensure that any user identifying information or device identifying information embedded in the data is removed. Thus, the user may have control over whether information is collected about the user and user's device, and how such information, if collected, may be used by the computing device and/or computing system.

In one example, a method is described that includes training, using features extracted from contextual information of a computing device, a sequence model to determine temporal or sequential characteristics of past user interactions with an application provider service that resulted in conversions from the application provider service; generating, by a computing system, using the sequence model, a sequence output that is indicative of one or more temporal or sequential characteristics of future user interactions with the application provider service that will result in a conversion of a particular application from the application provider service; training, based at least in part on the sequence output, an existing prediction model to identify a future context during which the future user interactions with the application provider service result in the conversion of the particular application from the application provider service; responsive to inputting, by the computing system, into the prediction model, a current context of the computing device that corresponds to the future context: obtaining, from the existing prediction model, an indication of the particular application; and modifying, by the computing system, based on the indication of the particular application, a user interface of the application provider service being accessed by the computing device such that the particular application is presented more prominently in the user interface than one or more other applications from the application provider service.

In another example, a computer-readable storage medium is described including instructions that, when executed, cause at least one processor to train, using features extracted from contextual information of a computing device, a sequence model to determine temporal or sequential characteristics of past user interactions with an application provider service that resulted in conversions from the application provider service, generate, using the sequence model, a sequence output that is indicative of one or more temporal or sequential characteristics of future user interactions with the application provider service that will result in a conversion of a particular application from the application provider service, and train, based at least in part on the sequence output, an existing prediction model to identify a future context during which the future user interactions with the application provider service result in the conversion of the particular application from the application provider service. Responsive to inputting, into the prediction model, a current context of the computing device that corresponds to the future context, the instructions, when executed, further cause the at least one processor to: obtain, from the existing prediction model, an indication of the particular application, and modify, based on the indication of the particular application, a user interface of the application provider service being accessed by the computing device such that the particular application is presented more prominently in the user interface than one or more other applications from the application provider service.

In another example, a computing system is described that includes at least one processor configured to train, using features extracted from contextual information of a computing device, a sequence model to determine temporal or sequential characteristics of past user interactions with an application provider service that resulted in conversions from the application provider service, generate, using the sequence model, a sequence output that is indicative of one or more temporal or sequential characteristics of future user interactions with the application provider service that will result in a conversion of a particular application from the application provider service, and train, based at least in part on the sequence output, an existing prediction model to identify a future context during which the future user interactions with the application provider service result in the conversion of the particular application from the application provider service. Responsive to inputting, into the prediction model, a current context of the computing device that corresponds to the future context, the at least one processor is further configured to: obtain, from the existing prediction model, an indication of the particular application, and modify, based on the indication of the particular application, a user interface of the application provider service being accessed by the computing device such that the particular application is presented more prominently in the user interface than one or more other applications from the application provider service.

In another example, a system is described including means for training, using features extracted from contextual information of a computing device, a sequence model to determine temporal or sequential characteristics of past user interactions with an application provider service that resulted in conversions from the application provider service; means for generating, using the sequence model, a sequence output that is indicative of one or more temporal or sequential characteristics of future user interactions with the application provider service that will result in a conversion of a particular application from the application provider service; means for training, based at least in part on the sequence output, an existing prediction model to identify a future context during which the future user interactions with the application provider service result in the conversion of the particular application from the application provider service; responsive to inputting, into the prediction model, a current context of the computing device that corresponds to the future context: means for obtaining, from the existing prediction model, an indication of the particular application; and means for modifying, based on the indication of the particular application, a user interface of the application provider service being accessed by the computing device such that the particular application is presented more prominently in the user interface than one or more other applications from the application provider service.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing system that relies on sequence modeling to account for temporal and/or sequential differences in user behavior when making predictions about future user interactions with the computing system, in accordance with one or more aspects of the present disclosure.

FIG. 2 is a block diagram illustrating an example computing system that relies on sequence modelling to account for temporal and/or sequential differences in user behavior when making predictions about future user interactions with the computing system, in accordance with one or more aspects of the present disclosure.

FIGS. 3A through 3E are conceptual diagrams illustrating aspects of an example machine-learned model according to example implementations of the present disclosure.

FIG. 4 is a conceptual diagram illustrating example indications of recommendations that are output by a computing device that accesses a computing system that relies on sequence modelling to account for temporal and/or sequential differences in user behavior when making predictions about future user interactions with the computing system, in accordance with one or more aspects of the present disclosure.

FIG. 5 is a flowchart illustrating example operations performed by an example computing system that relies on sequence modelling to account for temporal and/or sequential differences in user behavior when making predictions about future user interactions with the computing system, in accordance with one or more aspects of the present disclosure.

### DETAILED DESCRIPTION

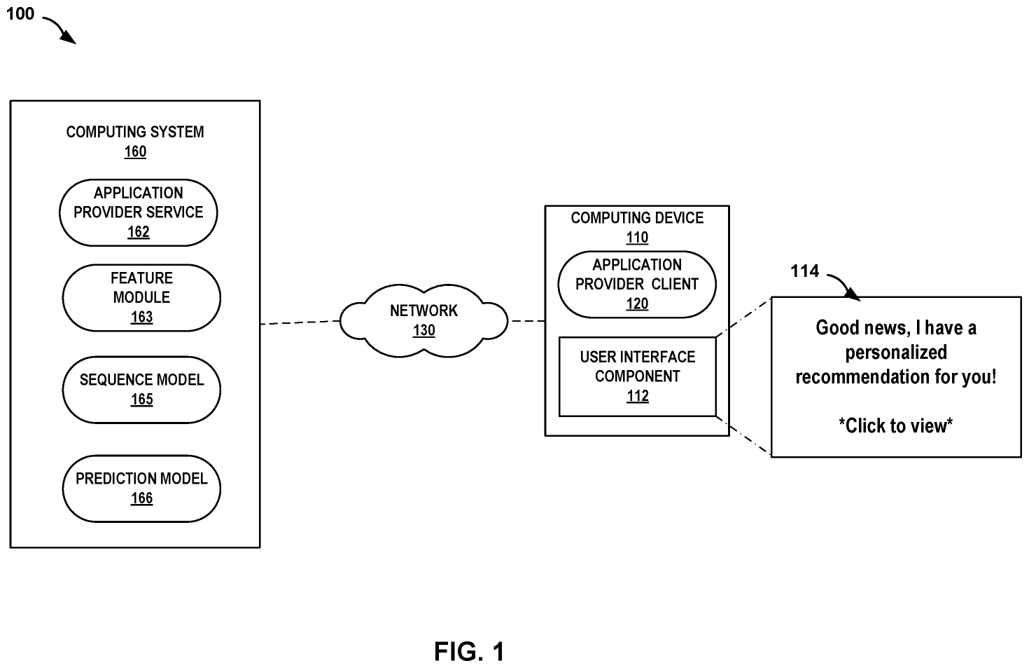

FIG. 1 is a conceptual diagram illustrating an example computing system that relies on sequence modelling to account for temporal and/or sequential differences in user behavior when making predictions about future user interactions with the computing system, in accordance with one or more aspects of the present disclosure. In general, system 100 of FIG. 1 uses one or more sequence models to include temporal and/or sequential characteristics or features of user behavior into predictions of future user behavior with system 100. System 100 may implement a composite model, that can be trained end-to-end, and which combines one or more deep neural networks (DNNs) with one or more sequence models to determine items that have features which may be of more interest to a user at a particular time and/or context, than other features, particularly given past sequential or temporal behaviors with system 100. System 100 may automatically learn relative degrees of importance for each of the different features and in some examples, use sequence modeling techniques to encode importance factors or weights to the sequential or temporal features so that all sequential or temporal features of a sequence output are not necessarily treated equally when making behavioral predictions.

System 100 may encode the sequential or temporal characteristics into a single, sequence output, in some examples, as a sequence embedding that can be input, along with other feature embeddings, into existing prediction models to better predict future user behaviors associated with system 100. In some examples, system 100 generate a sequence output indicative of latent crosses between primary feature embeddings and auxiliary temporal or sequential embeddings that are then used to enable a prediction model to improve its predictions of future user behaviors associated with system 100.

System 100 includes computing system 160 in communication, via network 130, with computing device 110. Although operations attributed to system 100 are described primarily as being performed by a single computing system 160 and a single computing device 110, in some examples, the operations of system 100 may be performed by additional or fewer computing devices and systems than what is shown in FIG. 1. For example, some of the operations attributed to computing system 160 may be performed by computing device 110, or vice versa. Furthermore, despite being primarily described in the context of an application provider service, an application provider service is just one example use-case for the described techniques of this disclosure. Many more example use-cases exist, including any other recommendation systems that try to predict items of interest for users.

Computing system 160 includes application provider service module 162, feature module 163, sequence model 165, and prediction model 166. Computing device 110 includes application provider client module 120 and user interface component (“UIC”) 112 which is configured to output user interface 114.

Network 130 represents any public or private communications network, for instance, cellular, Wi-Fi, and/or other types of networks, for transmitting data between computing systems, servers, and computing devices. Network 130 may include one or more network hubs, network switches, network routers, or any other network equipment, that are operatively inter-coupled thereby providing for the exchange of information between computing system 160 and computing device 110. Computing system 160 and computing device 110 may transmit and receive data across network 130 using any suitable communication techniques.

Computing system 160 and computing device 110 may each be operatively coupled to network 130 using respective network links. The links coupling computing system 160 and computing device 110 to network 130 may be Ethernet, ATM or other types of network connections, and such connections may be wireless and/or wired connections.

Computing system 160 represents any combination of one or more computers, mainframes, servers (including so-called “blades”), cloud computing systems, or other types of remote computing systems capable of exchanging information via network 130 as part of an application provider service. That is, computing system 160 may store, or provide access to, an application provider service (e.g., application store, application data base, application repository, or other collection of applications) from which a client device can download an application executable that the client device executes locally on-device. Computing system 160 may output application recommendations to client devices based on predictions of user behavior with regard to users of the client devices. For example, when making application recommendations one of the ways in which computing system 160 may predict future user behavior is by using a sequence model to account for temporal and/or sequential differences in user behavior. In some cases, computing system 160 outputs the recommendations and other information about the application provider service to computing device 110 for subsequent presentation, e.g., via user interface 114.

Computing device 110 represents any suitable computing device or computing system capable of exchanging information via network 130 to access the application provider service provided by computing system 160. For example, computing device 110 may be a mobile device from which a user provides inputs to interact with the application provider service handled by computing system 160 and to cause computing device 110 to download application executables from computing system 160, e.g., for local installation. Examples of computing device 110 include mobile phones, tablet computers, laptop computers, desktop computers, servers, mainframes, blades, wearable devices (e.g., computerized watches etc.), home automation devices, assistant devices, gaming consoles and systems, media players, e-book readers, television platforms, automobile navigation or infotainment systems, or any other type of mobile, non-mobile, wearable, and non-wearable computing devices configured to execute applications obtained from an application provider service, such as that provided by application provider service module 162.

UIC 112 of computing device 110 may function as an input and/or output device for computing device 110. UIC 112 may be implemented using various technologies. For instance, UIC 112 may function as an input device using presence-sensitive input screens, microphone technologies, infrared sensor technologies, or other input device technology for use in receiving user input. UIC 112 may function as output device configured to present output to a user using any one or more display devices, speaker technologies, haptic feedback technologies, or other output device technology for use in outputting information to a user.

Application provider service module 162 of computing system 160 controls operations of computing system 160 for implementing the application provider service provided by computing system 160. As previously indicated, an application provider service is just one example service provided by computing system 160. Other examples of services that benefit from the described techniques exist. In any case, in the application provider service context, application provider service module 162 may provide an interface between computing system 160 and client devices, such as computing device 110, that access the application provider service provided by computing system 160, e.g., to download application executables, obtain application recommendations, search for applications, browse for applications, or obtain reviews, news, updates, or other information about available or previously downloaded application executables.

Application provider client module 120 of computing device 110 provides the interface between computing device 110 and the application provider service managed by computing system 160. For example, application provider client module 120 may be a stand-alone application executing at computing device 110, or in some examples, application provider client module 120 may be a subroutine or internet application accessed from an internet browser executing at computing device 110. In either case, application provider client module 120 is configured to exchange information with computing system 160 to implement the application provider service. For example, application provider client module 120 may send, to application provider service module 162, an indication of user inputs directed to a user interface associated with the application provider service, e.g., user interface 114. Application provider client module 120 may receive, from application provider service module 162 and via network 130, application related files (e.g., libraries, executables, source files, and the like), updates, application recommendations, and other information about the application provider service of computing system 160 in response to the user inputs.

Modules 120 and 162 may perform operations described herein using software, hardware, firmware, or a mixture of hardware, software, and firmware residing in and/or executing at computing device 110 and computing system 160, respectively. at computing device 110 and computing system 160, may execute, respectively, module 120 and module 162 with multiple respective processors or multiple respective devices, as respective virtual machines executing on underlying hardware, as one or more respective services of an operating system or computing platform, and/or as one or more respective executable programs at an application layer of a respective computing platform.

For many computing systems that support online services, such as e-commerce services, music services, media services, video services, news services, gaming services, social networking services, application provider services, and the like, a user's recent, past engagement history may be a stronger indicator of the user's present intent and interests relative to those services when compared to other characteristics of the computing systems. For instance, a user that engages, on a regular basis and with some recency, with a computing system to purchase baby products from an online market place is more likely to continue purchase more baby products from the online market place, in the future. Similarly, a user that has interacted in the past with a computing system to download and play games is less likely to want to download and/or play additional games in the future if the previous game downloads occurred several years ago or in a much different context than the user's present context. Alternatively, the user is more likely to want to play additional games if the previous plays and downloads occurred in the recent past or under similar circumstances of the user's current context.

In accordance with the described techniques, computing device 110 and computing system 160 exchange information via network 130 to capture and model the sequential and temporal characteristics of user behaviors (e.g., a user's location history, purchase history, search history, engagement history, etc.) specifically as they pertain to interactions with system 100. The sequential and temporal characteristics may be encoded into one or more feature embeddings, referred to as “sequence embeddings”, using one or more LSTM models, attention models, or other type of sequence models. The sequence embeddings and other feature embeddings, such as application feature embeddings and user feature embeddings to name a few, are used as inputs to a DNN or other similar model for re-ranking or recommendation purposes. Said differently, system 100 may identify temporal and sequential characteristics of the user, based in part on the sequence embeddings, to model and predict future behaviors of the user, with regard to particular items that are available from computing system 160.

In short, sequence model 165 models and then predicts, the sequential and temporal characteristics of user behaviors specifically as they pertain to interactions with computing device 110 and the application provider service of computing system 160. Sequence model 165 obtains features from feature module 163 that overtime, enable sequence model 165 to model the sequential or temporal aspects of a user's behavior associated with system 100. Prediction model 166 of computing system 160 combines the output of sequence model 165 (e.g., a sequence embedding or latent crosses) with other feature embeddings obtained from feature module 163 (e.g., user feature embeddings indicative of other observed characteristics of the user, application feature embeddings indicative of application characteristics, etc.). The combined inputs enable prediction model 166 to model and then predict future behaviors of the user, during particular future engagements with the application provider service or for specific contexts, that are more likely to result in a conversion from the application provider service.

Application provider service module 162 may use the output of prediction model 166 to rank available applications from the application provider service in order of relevance to a current context of a user of computing device 110. In other words, application provider service module 162 may query prediction model 166 for one or more applications to recommend given a particular context of a user and/or computing device 110. Accordingly, application provider service module 162 may more appropriately recommend applications based (at least in part) on the users observed and expected temporal or sequential behavior on the application provider service.

As eluded to above, feature module 163 is a feature extractor that outputs feature embeddings for use in machine-learned models that execute on computing system 160. The feature embeddings are indicative of various characteristics of system 100, the application provider service, and the user of computing device 110 that have been extracted from contextual information associated with the user, computing device 110, and the application provider service. In other words, feature module 163 is configured to gather contextual information related to system 100, and then generate, based on the contextual information, various feature embeddings that are specifically tailored for use as inputs to models 165 and 166. Feature module 163 may perform operations described herein using software, hardware, firmware, or a mixture of hardware, software, and firmware residing in and/or executing at computing system 160. Computing system 160 may execute feature module 163 with multiple processors or multiple devices, as virtual machines executing on underlying hardware, as one or more services of an operating system or computing platform, and/or as one or more executable programs at an application layer of a computing platform of computing system 160.

As used throughout the disclosure, the term “contextual information” refers to any conceivable information that may be used by a computing system and/or computing device, such as computing system 160 and computing device 110, to make inferences or predictions about future user and device behaviors associated with system 100. Contextual information may include: device location and/or sensory information, user topics of interest (e.g., a user's favorite “things” typically maintained as a user interest graph or some other type of data structure), contact information associated with users (e.g., a user's personal contact information as well as information about a user's friends, co-workers, social media connections, family, etc.), search histories, location histories, long-term and short-term tasks, calendar information, application usage histories, purchase histories, items marked as favorites, electronic bookmarks, and other information that computing device 110 and computing system 160 can gather about a user of computing device 110 from interactions with system 100. Furthermore, contextual information may include information about the operating state of a computing device. For example, an application that is executed at a given time or in a particular location is an example of information about the operating state of a computing device. Other examples of contextual information based on the operating state of a computing device include, but are not limited to, positions of switches, battery levels, whether a device is plugged into a wall outlet or otherwise operably coupled to another device and/or machine, user authentication information (e.g., which user is currently authenticated-on or is the current user of the device), whether a device is operating in “airplane” mode, in standby mode, in full-power mode, the operational state of radios, communication units, input devices and output devices, etc.

In contrast to “contextual information” the term “context” refers to a particular state of a collection of characteristics associated with a computing device and/or a user of a computing device, at a particular time. The context may indicate characteristics associated with the physical and/or virtual environment of the user and/or the computing device at various locations and times. As some examples, a context of a computing device may specify an acoustic fingerprint, a video fingerprint, a location, a movement trajectory, a direction, a speed, a name of a place, a street address, a type of place, a building, weather conditions, and traffic conditions, at various locations and times. As some additional examples, the context of a computing device may specify a calendar event, a meeting, or other event associated with a location and/or time.

In some examples, a context of a computing device may specify any webpage addresses accessed at a particular time, one or more text entries made in data fields of the webpages at particular times, including search or browsing histories, product purchases made at particular times, product wish lists, product registries, and other application usage data associated with various locations and times. The context of the computing device may further specify audio and/or video accessed by or being broadcast in the presence of the computing device at various locations and times, television or cable/satellite broadcasts accessed by or being broadcast in the presence the computing device at various locations and times, and information about other services accessed by the computing device at various locations and times.

When collecting, storing, and using contextual information or any other user or device data, computing system 160 and computing device 110 may take precautions to ensure that user privacy is preserved. That is, computing system 160 and computing device 110 may only collect, store, and analyze contextual information if computing system 160 and computing device 110 receive explicit permission of individual users from which the contextual information originates. For example, in situations discussed below in which application service provider module 162 may collect information for inferring temporal or sequential user behavior, a user of computing device 110 may be provided with an opportunity to provide input to computing device 110 or computing system 160 to control whether application provider service module 162 can collect and make use of their information. The individual users may further be provided with an opportunity to control what application provider service module 162 can or cannot do with the information.

Any data being collected may be pre-treated in one or more ways before it is transferred to, stored by, or otherwise used by computing device 110 and computing system 160, so that personally-identifiable information is removed. For example, before application provider service module 162 collects contextual information obtained by feature module 163, computing device 110 may pre-treat the contextual information to ensure that any user identifying information or device identifying information embedded in the contextual information is removed before being transferred to computing system 160. In other examples, computing system 160 may pre-treat the performance data upon receipt and before storing or making use of the contextual information. In either case, the user may have complete control over whether contextual information is collected, and if so, how such information may be used by computing device 110 and computing system 160.

Feature module 163 may use one or more rules or models to extract specific embedding features from contextual information and output the extracted features to models 165 and 166. In other words, feature module 163 is configured to identify, from one or more pieces of contextual information of computing device 110 and/or a user of computing device 110, specific signals that indicate a particular state or particular condition of some aspect of system 100, at a particular moment in time. Feature module 163 may include one or more trained models, rules-based models, or other types of models that receive as input, contextual information, and provide as output, one or more feature embeddings for use as inputs to models 163 and 165.

For example, feature module 163 may obtain application usage information from contextual information obtained from computing device 110. From metadata associated with the most recently or more frequently used applications indicated in the application usage information, feature module 163 may extract various feature embeddings.

Numerous types of embedding features are possible. Such feature embeddings may be temporal or sequential type embeddings or other (i.e., non-temporal and non-sequential) types of embeddings, like application feature embeddings or user feature embeddings. Some examples of temporal or sequential type feature embeddings include: most recently installed application(s), most frequently executed application(s), most frequently executed game(s), and most frequently accessed media (e.g., whether song, album, video, show, e-book, or other media). Examples of other types of feature embeddings (e.g., application type or user type) that may be extracted, specifically for making application recommendations, may include: application name, application developer, application publisher, user's location, user's attention level, user's age, user's education level, user's mood, user's favorites, user's friends and family, and the like.

Feature module 163 may append, group, or otherwise combine some feature embeddings with additional feature embeddings. That is, feature module 163 may extract one or more primary embeddings and append to the primary embeddings, one or more auxiliary embeddings that provide further detail about the primary embeddings. For example, feature module 163 may label, as primary sequence embeddings, one or more of: most recently installed application, most frequently executed application(s), most frequently executed game(s), and most frequently accessed media (e.g., whether song, album, video, show, e-book, or other media).

For any of the primary sequence embeddings, feature module 163 may associate any of the following auxiliary, sequence embeddings which specifically relate to sequential characteristics of user behavior: quantity of active users associated with an application, quantity of sessions associated with the application, quantity of sessions relative total sessions of all applications, average user rating of the application, global category rank for contributing to total application purchases made by all users, user specific category rank for contributing to total application purchases made by the user, quantity of user-initiated installations, ratio of user-initiated installations relative total application installations, days since release of the application, duration of use of the application, title, category, developer. For each of the primary sequence embeddings, feature module 163 may associate any of the following auxiliary, sequence embeddings which specifically relate to temporal characteristics of user behavior: the time duration from when an application is installed to when feature module 163 recognizes an interaction with the application, and any delta in the preceding time duration relative to other applications.

Feature module 163 may subsequently obtain new contextual information and update the extracted features. In this way, feature module 163 may continuously extract feature embeddings from a user's interaction with system 100 to regularly feed models 165 and 166 with current information about a user's present interests as they might relate to a service provided by system 100.

Sequence model 165 is configured to capture the sequential and/or temporal nature of user behavior with respect to computing system 160 as, for example, one or more sequence embeddings, or one or more latent crosses between primary feature embeddings and auxiliary sequence embeddings, that are relied on by prediction model 166. When executed by computing system 160, sequence model 165 may be trained, using sequential or temporal embeddings obtained from feature module 163. Once trained, sequence model 165 may determine the temporal or sequential characteristics of past user interactions with the application provider service that resulted in conversions of the applications (e.g., downloads, bookmarks, etc.) from the application provider service. Sequence model 165 may output an indication of these temporal or sequential characteristics of past user interactions with the application provider service that resulted in conversions of the applications as one or more sequence embeddings, e.g., uses by prediction model 166 in making an overall prediction about a future device or user interaction with system 100. Sequence model 165 may be implemented as a LSTM model, attention model, or other suitable sequence model. Further details about the specific architecture of sequence model 165 is evidenced below with reference to the remaining FIGS.

Prediction model 166 is configured to model the overall nature of user behavior, not just the sequential and/or temporal aspects, with respect to system 100 to deliver a ranking or recommendation of available applications from the application provider service of computing system 160. Prediction model 166 may receive as input one or more application feature embeddings, user embeddings, sequence embeddings, or other embeddings for a particular context and provide as output, an indication of zero or more available applications from the application provider service to recommend in this particular context. As an alternative to receiving sequence embeddings as inputs, or in addition to receiving the sequence embeddings as inputs, prediction model 166 may receive as input one or more latent crosses between various sequence embeddings (e.g., primary sequence embeddings and auxiliary sequence embeddings) to use in identifying applications to recommend for a particular context.

When executed by computing system 160, prediction model 166 may be trained, using embeddings obtained from feature module 163 and sequence model 165. Once trained, prediction model 166 may determine the characteristics of past user interactions with the application provider service that resulted in conversions of the applications for various different contexts. Prediction model 166 may rank or provide information for application provider service module 162 to rank, available applications to determine an application recommendation for a user at a particular time. Prediction model 166 may be implemented as a DNN model or other type model. Further details about the specific architecture of sequence model 166 is found below with reference to the remaining FIGS.

In operation, a user of computing device 110 may search or browse for available applications from the application provider service of computing system 160. The user may provide input at a presence-sensitive screen of UIC 112 at or near a location of UIC at which user interface 114 is displayed. UIC 112 may provide information about the input to application provider client module 120 and in response to the information about the input, application provider client module 120 may access the application provider service managed by application provider service module 162. After having received explicit permission from the user of computing device 110 to collect and make use of contextual information associated with computing device 110, application provider service module 162 of computing system 160 may determine an application recommendation.

For example, having been trained using historical interaction data associated with an application provider service, sequence model 165 may determine temporal or sequential characteristics of past user interactions with the application provider service that result in conversions from the application provider service. Sequence model 165 may, as an example, generate a sequence output, such as one or more sequence embeddings indicative of the temporal or sequential features extracted by feature module 163 from contextual information of computing device 110. Sequence model 165 may provide the sequence output to prediction model 166 to enable model 166 identify when observing future user behaviors, when a recommendation of a particular application is likely to cause a user input that results in a conversion of the particular application from the application provider service.

Having been trained by the sequence outputs from sequence model 165, prediction model 166 may identify a future context during which future user interactions with the application provider service will result in conversions of particular applications from the application provider service. For example, responsive to application service provider 162 inputting an indication of a current context of computing device 110 (e.g., obtained from feature extractor module 163), prediction module 166 may determine whether the current context is indicative of a scenario in which a user of computing device 110 will download a particular application from the application provider service.

Prediction module 166, in response to determining that a current context corresponds to a future context in which a particular application is likely to be downloaded, may output an indication of the prediction. Application provider service module 162 may communicate via network 130 with application provider client module 120 about the prediction made be prediction module 166. Application service module 162 may send an indication of the particular application predicted by prediction module 166 along with instructions that cause application service client module 120 to modify, based on the indication of the particular application, user interface 114 such that the particular application is presented within user interface 114 more prominently than one or more other applications from the application provider service. For example, user interface 114 may include a text, graphics, sounds, and/or other types of information to convey to the user that, given his or her particular context, the particular application is recommended for download more than any other application.

By enabling existing systems to more easily account for temporal or sequential differences in user behavior, the described techniques may improve the accuracy of existing prediction or ranking systems, without requiring much if any re-engineering of an existing prediction model, to account for such differences. That is, an existing prediction or ranking system may already rely on other, pre-existing feature embeddings for making predictions about items in a prediction space. In a similar way, these existing systems can easily be reconfigured to also rely on all new sequence embeddings that are indicative of the temporal or sequential aspects of user behavior with the items. Accordingly, by accounting for temporal or sequential differences in user behavior, an example computing system may perform better, operate more efficiently, and perhaps result in a more useful user experience. The example computing system may therefore minimize frustrations users may otherwise experience from interactions with a less accurate prediction or ranking system.

Throughout the disclosure, examples are described where a computing device and/or computing system may analyze information (e.g., contextual information, user and/or device interaction data, etc.) only if the computing device and/or the computing system receives explicit permission from a user of the computing device and/or the computing system. For example, in situations discussed below in which the computing device and/or computing system may collect information about user interactions with applications executing at computing devices or computing systems, individual users may be provided with an opportunity to provide input to control whether programs or features of the computing device and/or computing system can collect and make use of the information. The individual users may further be provided with an opportunity to control what the programs or features can or cannot do with the information.

In addition, information collected may be pre-treated in one or more ways before it is transferred, stored, or otherwise used by a computing device and/or computing system, so that personally-identifiable information is removed. For example, before an example computing system stores user interaction data associated with an application executing at a computing device, the example computing system may pre-treat the data to ensure that any user identifying information or device identifying information embedded in the data is removed. Thus, the user may have control over whether information is collected about the user and user's device, and how such information, if collected, may be used by the computing device and/or computing system.

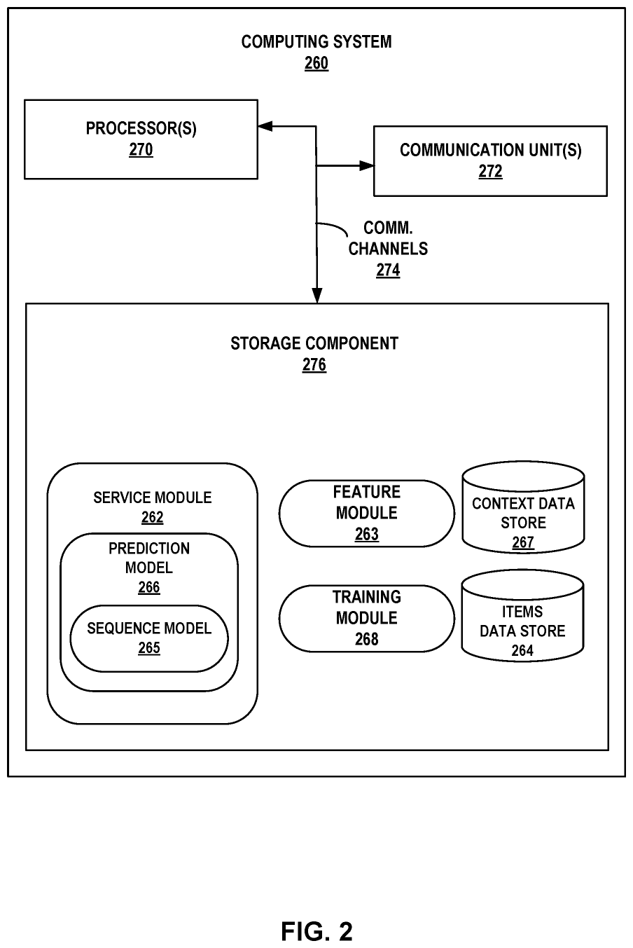

FIG. 2 is a block diagram illustrating an example computing system that relies on sequence modelling to account for temporal and/or sequential differences in user behavior when making predictions about future user interactions with the computing system, in accordance with one or more aspects of the present disclosure. Computing system 260 of FIG. 2 is described below as an example of computing system 160 of FIG. 1. FIG. 2 illustrates only one particular example of computing system 260, and many other examples of computing system 260 may be used in other instances and may include a subset of the components included in computing system 260 or may include additional components not shown in FIG. 2.

As shown in the example of FIG. 2, computing system 260 includes one or more processors 270, one or more communication units 272, and one or more storage components 276 communicatively coupled via communication channel 274. Storage components 276 include instructions and data for executing service module 262, feature module 263, training module 268, items data store 264, and training module 268. Service module 262 includes prediction model 266. In the example of FIG. 2, prediction model 266 is a composite model that includes sequence model 265. In other examples, prediction model 266 and sequence model 265 may be separate—distinct components of computing system 260.

Communication channels 274 may interconnect each of the components 266, 270, 272, and 276 for inter-component communications (physically, communicatively, and/or operatively). In some examples, communication channels 274 may include a system bus, a network connection, an inter-process communication data structure, or any other method for communicating data.

One or more communication units 272 of computing system 260 may communicate with external devices (e.g., computing device 110 of FIG. 1) via one or more wired and/or wireless networks (e.g., network 130 of FIG. 1) by transmitting and/or receiving network signals on the one or more networks. Examples of communication units 272 include a network interface card (e.g. such as an Ethernet card), an optical transceiver, a radio frequency transceiver, a GPS receiver, or any other type of device that can send and/or receive information. Other examples of communication units 272 may include short wave radios, cellular data radios, wireless network radios, as well as universal serial bus (USB) controllers.

One or more storage components 276 within computing system 260 may store information for processing during operation of computing system 260 (e.g., computing system 260 may store contextual information at context data store 267 that has been collected and processed by feature module 263 during execution at computing system 260). In some examples, storage component 276 is a temporary memory, meaning that a primary purpose of storage component 276 is not long-term storage. Storage components 276 on computing system 260 may be configured for short-term storage of information as volatile memory and therefore not retain stored contents if powered off. Examples of volatile memories include random access memories (RAM), dynamic random-access memories (DRAM), static random access memories (SRAM), and other forms of volatile memories known in the art.

Storage components 276, in some examples, also include one or more computer-readable storage media. Storage components 276 in some examples include one or more non-transitory computer-readable storage mediums. Storage components 276 may be configured to store larger amounts of information than typically stored by volatile memory. Storage components 276 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 276 may store program instructions and/or information (e.g., data) associated with modules 262, 263, and 268, models 265 and 266, and data stores 264 and 267. Storage components 276 may include a memory configured to store data or other information associated with modules 262, 263, and 268, models 265 and 266, and data stores 264 and 267.

One or more processors 270 may implement functionality and/or execute instructions associated with modules 262, 263, and 268, models 265 and 266, and data stores 264 and 267 of computing system 260. Examples of processors 270 include application processors, display controllers, graphics processors, auxiliary processors, one or more sensor hubs, and any other hardware configure to function as a processor, a processing unit, or a processing device. Modules 262, 263, and 268, models 265 and 266, and data stores 264 and 267 may be operable by processors 270 to perform various actions, operations, or functions of computing system 260. For example, processors 270 of computing system 260 may retrieve and execute instructions stored by storage components 276 that cause processors 270 to perform operations attributed to modules 262, 263, and 268, models 265 and 266, and data stores 264 and 267. The instructions, when executed by processors 270, may cause computing system 260 to store information within storage components 276.

Items data store 264 contains items, and related information, that are available from a service provided by service module 262. For example, in the context of an application provider service, items data store 264 may include one or more available applications as well as respective feature embeddings associated with those applications. When providing a recommendation, service module 262 and/or models 265 and 266 may perform a feature embedding look-up at data store 264 to identify any applications that have feature embeddings which may correlate to an item download for a particular context. In other words, service module 262 may obtain from feature model 263, one or more features that define a current context of computing device 110. Service module 262 may provide the features to models 266 and 265 to obtain a recommendation for an item stored at items data store 264 or a recommendation for features of items stored at items data store 264 to look-for, before making a recommendation. Items data store 264 may contain other information associated with items available from the service of service module 262, including but not limited to, metadata, auxiliary features, primary features, and the like.

Feature module 263 may include some or all of the functionality of feature module 163 of computing system 160 of FIG. 1. Feature module 263 may perform similar operations as feature module 163 for extracting embedding features from contextual information obtained from external computing devices that engage with one or more services of service module 262. Feature module 263 may provide the embedding features to training module 268 as well as to models 265 and 266 for subsequent use by models 265 and 266 to enable service module 262 to recommend items for a particular context.

Feature module 263 may collect and store the contextual information, associated feature embeddings, or other information at context data store 267. Feature module 263 may organize the contextual information, associated feature embeddings, or other information stored at context data store 267 such that the information stored at context data store 267 is easily searchable and retrievable. For example, feature module 263 may provide a service to other components of computing system 260 that enable the other components to obtain feature embeddings and/or other information about a current context of a computing device, such as computing device 110. For instance, service module 262 may obtain, from feature module 263, an indication of a current context of computing device 110 being maintained at context data store 267. The indication of the current context may include one or more feature embeddings that define the current context. Service module 262 may provide the feature embeddings that define the current context to prediction model 266 and sequence model 265 to obtain a prediction about which items of computing systems 260 that a user of computing device 110 is more likely interested, for the current context.

Training module 268 is configured to train models 265 and 266. That is, training module 268 may provide respective training data to models 265 and 266 including a series of expected inputs and a corresponding series of expected outputs. Models 265 and 266 may learn what constitutes an appropriate output given variations in inputs to overtime make predictions and determine an appropriate output given future, real-world inputs.

Service module 262 may include some or all of the functionality of application provider service module 162 of computing system 160 of FIG. 1. Service module 262 may additionally include some or all of the functionality of application provider client module 120 of computing device 110 of FIG. 1. Service module 262 may perform similar operations as modules 162 and 120 for providing an item retrieval service, such as an application provider service, a music streaming service, or other similar service that recommends items that are relevant to a current context, particularly given a past temporal and sequential behaviors with computing system 260.

Service module 262 may provide a user interface associated with the service provided by service module 262. For example, Service module 262 may host a web interface from which a client, such as computing device 110, can access the service provided by service module 262. For example, a user of computing device 110 may interact with a web browser or other application (e.g., application provider client module 120) executing at or accessible from computing device 110. Service module 262 may send information to the web browser or other application that causes the client to display a user interface, such as user interface 114 of FIG. 1.

Prediction model 266 and sequence model 265 are shown in the example of FIG. 2 as being a composite model configured to recommend items based on observed temporal and sequential user behaviors with service module 262. In other examples, models 266 may be separate and distinct models such that at least one input of model 266 is tied to at least one output of model 265.

Prediction model 266 is an example of prediction model 166 of FIG. 1 including some or all of the functionality of prediction model 166 of computing system 160 of FIG. 1. Prediction model 266 may be a DNN or other type model configured to return one or more recommended items from items data store 264 that are appropriate for a given context. That is, prediction model 266 may receive as input, the items and corresponding feature embeddings of the items, from data store 264 as well as an indication of a current context from feature module 263. Based on the inputs, and by relying on sequence model 265, prediction model 266 may output a ranking of one or more items from items data store 264 that are suitable for recommending in the current context, particularly given the observed sequential or temporal nature of user behavior with respect to computing system 260 and previously retrieved items.

Sequence model 265 of prediction model 266 is an example of sequence model 165 of FIG. 1 including some or all of the functionality of sequence model 165 of computing system 160 of FIG. 1. Sequence model 265 may be implemented in various ways using one or more different types of sequence models, including LSTM models, attention models, RNN models, and the like.

In some examples, sequence model 265 may include an LSTM portion and an attention model portion. The LSTM portion of sequence model 265 may be implemented as one or more LSTM models, for instance, Gated Recurrent Units, that receive as input, one or more sequential or temporal feature embeddings from feature module 263. As one or more LSTM models, sequence model 265 may encode and output, a sequence embedding that is indicative of observed temporal or sequential characteristics of the feature embeddings. One benefit of LSTM modeling in this example is the ability to overtime learn which items from a user's history are more indicative of future behavior.

The attention model portion of sequence model 265 may be implemented as one or more attention models. One benefit of attention modeling in this example is the ability to overtime learn which feature embeddings from a user's history correlate with specific future behaviors. The sequence embedding (e.g., a sequential feature vector) may be encoded into a sing, average embedding. The average embedding may be individually concatenated to each of one or more sequential or temporal feature embeddings from feature module 263. The concatenated one or more sequential or temporal feature embeddings from feature module 263 are input with the average embedding into one or more fully connected hidden layers of the attention model. The output of a final hidden layer from the one or more fully connected hidden layers may be passed to a linear layer to obtain a weighting of each of the features in the sequence embedding, for example, as shown in EQ. 1.

$${a}_{i} = \frac{{e}^{{w}_{i}}}{{\sum }_{k = 1}^{{T}_{x}} {e}^{{w}_{k}}} \qquad EQ . 1$$

In EQ. 1, aᵢ is the normalized weight of element i in a sequence, wᵢ is the weight of the element i, Tₓ is the length of the sequence. In any case, after normalizing using a SoftMax function or other weighting/normalization technique, the attention model may output a respective weight or factor to apply to each element from the sequence embedding.

A weighted embedding c may be computed as shown in EQ. 2, where i is the weighted embedding of the sequence and νᵢ is the learned embedding vector of element i in the sequence.

$$c = {\sum }_{i = 1}^{T x} {a}_{i} {v}_{i} \qquad EQ . 2$$

In some examples, an attention model used by sequence model 265 may include one or more self-attention models. For example, sequence model 265 may calculate a cosine similarity matrix on feature embeddings of previously retrieved items from system 260 (e.g., all applications downloaded from computing system 160 to computing device 110). The self-attention model may concatenate the inputted sequential or temporal feature embeddings with the cosine similarity matrix in addition to

The concatenated inputs may additionally be fed into a linear layer of the attention model to obtain a weighting of each of the features in the sequence embedding, e.g., using a SoftMax function or other normalizing/weighting technique. After weighting, each previously retrieved item's (e.g., each previously installed application's) individual context is appended to a respective item embedding (e.g., an application embedding) for that item.

Sequence model 265 may handle features that include additional, sub-features or auxiliary features. In some examples, a sequence embedding is a coded combination of multiple temporal or sequential characteristics of future user interactions with a service that will result in a conversion of a particular item from the service. In some examples, a sequence embedding is a coded combination of a single temporal or sequential characteristic of future user interactions with a service that will result in a conversion of a particular item from the service.

Feature module 263 may append, group, or otherwise combine some feature embeddings with additional feature embeddings. Feature module 263 may extract one or more primary embeddings and append to the primary embeddings, one or more auxiliary embeddings that provide further detail about the primary embeddings. Sequence model 265 may encode primary and auxiliary features together into a single sequence embedding that sequence model 265 outputs as a sequence output.

In order to work with feature embeddings that include primary and auxiliary features, some additional considerations may be required to implement prediction model 266 and sequence model 265, although such consideration may not be appropriate for all sequence modelling in accordance with the described techniques. For example, in some cases, auxiliary features should not be the same as any primary feature embeddings so as to avoid increasing a size of sequence model 265. Further, in some examples, primary features should be encoded with associated auxiliary features using a single sequence model (e.g., as opposed to using a different sequence model to encode auxiliary features than what was used to encode primary features). A further consideration is to use a separate sequence model for each primary feature and its corresponding auxiliary features. In other words, if two primary features are to be encoded by sequence model 265, sequence model 265 may include two sequence attention models, one model for each primary feature, to encode the primary and auxiliary features into two different sequence embeddings.

Primary and secondary features may be combined and/or encoded in various ways. For instance, sequence model 265 may combine and/or code according to any of the following: by concatenating sparse features (i.e., those features with less information) together with dense features (i.e., those features with more information); by converting dense features into sparse features and then concatenating the converted dense and originally spare features; by using separate sequence models for sparse features and then the sequence models used for dense features; or by treating temporal sequence features different from sequential features.

Some of auxiliary features may be more important than other auxiliary features. For instance, temporal features such as time delta between item retrieval and when the item retrieval is used for prediction purposes (e.g., the difference between application install time at computing device 110 and the time when sequence model 265 uses extracted features from item retrieval) may be important for predicting future item retrievals.

There are different ways to combine temporal or sequential feature with other features. In some cases, multiplicative interaction may provide tighter binding of the sequential and temporal features, thus improving performance. For example, temporal features can be encoded differently from other features. Because there may be a one-to-one correspondence in the sequential features and temporal features, sequence model 265 may conduct an element wise multiplication of the sequence outputs from the attention or other models of sequence model 265.

In EQ. 3, z is an output embedding and ⊙ is an element wise multiplication operator. EQ. 3 can be extended to represent multiple hidden layers.

z=ReLu[(Wₛxₛ+b)⊙(Wₜxₜ+b)] EQ. 3

In addition to attention models, similar techniques may be applied to RNN models, LSTM models, alike. For example, in some cases, after encoding the features using LSTM model, sequence model 265 may use latent crosses to perform element-wise multiplication.

In some examples, the sequence output from sequence model 265 may enable prediction model to use one or more skip connections to improve performance. For example, given that there may be a large number of temporal or spatial features to extract from interactions with computing system 260, simply concatenating a sequence embedding output with other feature embeddings as input into prediction model 266 (e.g., a DNN model) may not provide enough performance lift. To ensure that sequence embeddings are properly emphasized and not looked in view of other feature embeddings, prediction model 266 may include skip connections between each hidden layer. In transitioning from one layer to the next, prediction model 266 may concatenate a sequence embedding to the input of each of the hidden layers.

In any event, she sequence embeddings can be either concatenated with other feature embeddings or they can be latently crossed with hidden layers. Such latent crosses may improve the performance as compared to concatenating an input to model 266, as the performance effects from temporal or sequential modeling is better realized and not overshadowed by existing feature embeddings.

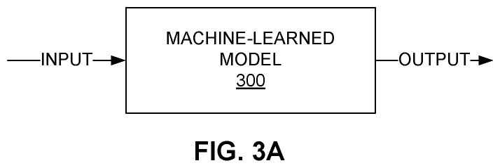

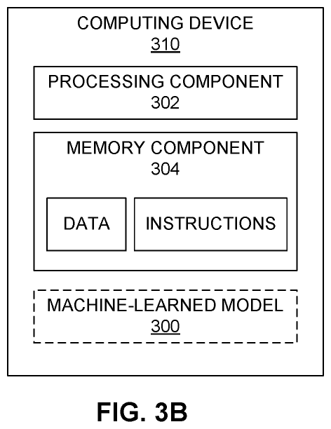

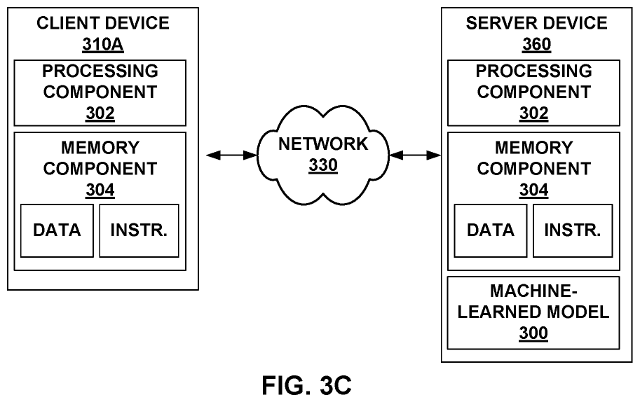

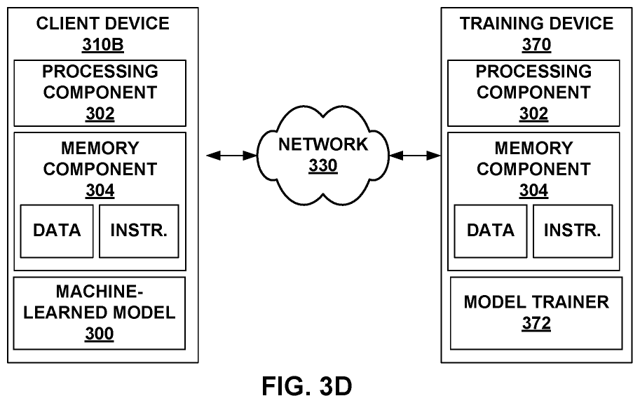

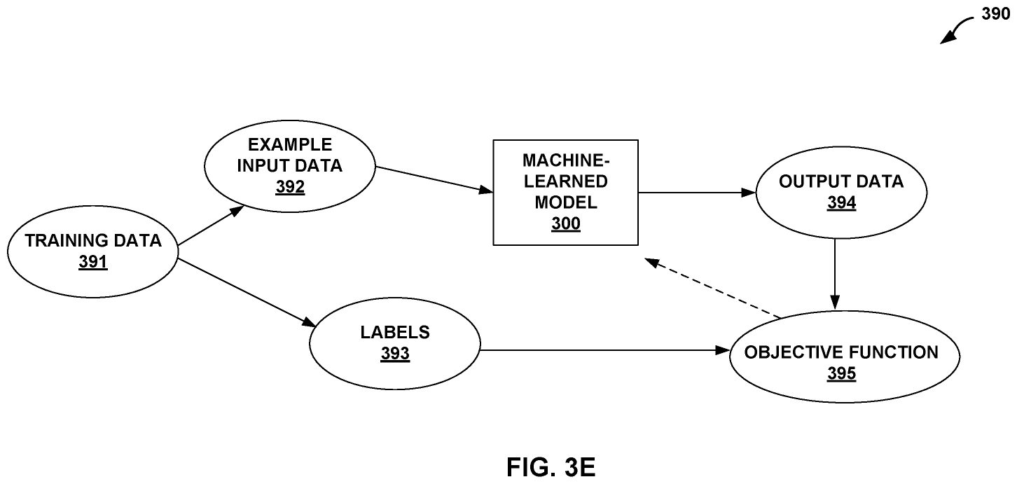

FIGS. 3A through 3E are conceptual diagrams illustrating aspects of an example machine-learned model according to example implementations of the present disclosure. FIGS. 3A through 3E are described below in the context of models 165, 166, 265, and 266 of FIGS. 1 and 2. For example, in some instances, machine-learned model 300, as referenced below, may be an example of any of models 165, 166, 265, and 266.

FIG. 3A depicts a conceptual diagram of an example machine-learned model according to example implementations of the present disclosure. As illustrated in FIG. 3A, in some implementations, machine-learned model 300 is trained to receive input data of one or more types and, in response, provide output data of one or more types. Thus, FIG. 3A illustrates machine-learned model 300 performing inference.

The input data may include one or more features that are associated with an instance or an example. In some implementations, the one or more features associated with the instance or example can be organized into a feature vector. In some implementations, the output data can include one or more predictions. Predictions can also be referred to as inferences. Thus, given features associated with a particular instance, machine-learned model 300 can output a prediction for such instance based on the features.

Machine-learned model 300 can be or include one or more of various different types of machine-learned models. In particular, in some implementations, machine-learned model 300 can perform classification, regression, clustering, anomaly detection, recommendation generation, and/or other tasks.

In some implementations, machine-learned model 300 can perform various types of classification based on the input data. For example, machine-learned model 300 can perform binary classification or multiclass classification. In binary classification, the output data can include a classification of the input data into one of two different classes. In multiclass classification, the output data can include a classification of the input data into one (or more) of more than two classes. The classifications can be single label or multi-label. Machine-learned model 300 may perform discrete categorical classification in which the input data is simply classified into one or more classes or categories.

In some implementations, machine-learned model 300 can perform classification in which machine-learned model 300 provides, for each of one or more classes, a numerical value descriptive of a degree to which it is believed that the input data should be classified into the corresponding class. In some instances, the numerical values provided by machine-learned model 300 can be referred to as “confidence scores” that are indicative of a respective confidence associated with classification of the input into the respective class. In some implementations, the confidence scores can be compared to one or more thresholds to render a discrete categorical prediction. In some implementations, only a certain number of classes (e.g., one) with the relatively largest confidence scores can be selected to render a discrete categorical prediction.

Machine-learned model 300 may output a probabilistic classification. For example, machine-learned model 300 may predict, given a sample input, a probability distribution over a set of classes. Thus, rather than outputting only the most likely class to which the sample input should belong, machine-learned model 300 can output, for each class, a probability that the sample input belongs to such class. In some implementations, the probability distribution over all possible classes can sum to one. In some implementations, a Softmax function, or other type of function or layer can be used to squash a set of real values respectively associated with the possible classes to a set of real values in the range (0, 1) that sum to one.

In some examples, the probabilities provided by the probability distribution can be compared to one or more thresholds to render a discrete categorical prediction. In some implementations, only a certain number of classes (e.g., one) with the relatively largest predicted probability can be selected to render a discrete categorical prediction.

In cases in which machine-learned model 300 performs classification, machine-learned model 300 may be trained using supervised learning techniques. For example, machine-learned model 300 may be trained on a training dataset that includes training examples labeled as belonging (or not belonging) to one or more classes. Further details regarding supervised training techniques are provided below in the descriptions of FIGS. 3B through 3E.

In some implementations, machine-learned model 300 can perform regression to provide output data in the form of a continuous numeric value. The continuous numeric value can correspond to any number of different metrics or numeric representations, including, for example, currency values, scores, or other numeric representations. As examples, machine-learned model 300 can perform linear regression, polynomial regression, or nonlinear regression. As examples, machine-learned model 300 can perform simple regression or multiple regression. As described above, in some implementations, a Softmax function or other function or layer can be used to squash a set of real values respectively associated with a two or more possible classes to a set of real values in the range (0, 1) that sum to one.

Machine-learned model 300 may perform various types of clustering. For example, machine-learned model 300 can identify one or more previously-defined clusters to which the input data most likely corresponds. Machine-learned model 300 may identify one or more clusters within the input data. That is, in instances in which the input data includes multiple objects, documents, or other entities, machine-learned model 300 can sort the multiple entities included in the input data into a number of clusters. In some implementations in which machine-learned model 300 performs clustering, machine-learned model 300 can be trained using unsupervised learning techniques.

Machine-learned model 300 may perform anomaly detection or outlier detection. For example, machine-learned model 300 can identify input data that does not conform to an expected pattern or other characteristic (e.g., as previously observed from previous input data). As examples, the anomaly detection can be used for fraud detection or system failure detection.

In some implementations, machine-learned model 300 can provide output data in the form of one or more recommendations. For example, machine-learned model 300 can be included in a recommendation system or engine. As an example, given input data that describes previous outcomes for certain entities (e.g., a score, ranking, or rating indicative of an amount of success or enjoyment), machine-learned model 300 can output a suggestion or recommendation of one or more additional entities that, based on the previous outcomes, are expected to have a desired outcome (e.g., elicit a score, ranking, or rating indicative of success or enjoyment). As one example, given input data descriptive of a context of a computing device, such as computing device 110 of FIG. 1, a recommendation system, such as computing system 160 of FIG. 1, can output a suggestion or recommendation of an application that the user might enjoy or wish to download to computing device 110.

Machine-learned model 300 may, in some cases, act as an agent within an environment. For example, machine-learned model 300 can be trained using reinforcement learning, which will be discussed in further detail below.

In some implementations, machine-learned model 300 can be a parametric model while, in other implementations, machine-learned model 300 can be a non-parametric model. In some implementations, machine-learned model 300 can be a linear model while, in other implementations, machine-learned model 300 can be a non-linear model.

As described above, machine-learned model 300 can be or include one or more of various different types of machine-learned models. Examples of such different types of machine-learned models are provided below for illustration. One or more of the example models described below can be used (e.g., combined) to provide the output data in response to the input data. Additional models beyond the example models provided below can be used as well.

In some implementations, machine-learned model 300 can be or include one or more classifier models such as, for example, linear classification models; quadratic classification models; etc. Machine-learned model 300 may be or include one or more regression models such as, for example, simple linear regression models; multiple linear regression models; logistic regression models; stepwise regression models; multivariate adaptive regression splines; locally estimated scatterplot smoothing models; etc.

In some examples, machine-learned model 300 can be or include one or more decision tree-based models such as, for example, classification and/or regression trees; iterative dichotomiser 3 decision trees; C4.5 decision trees; chi-squared automatic interaction detection decision trees; decision stumps; conditional decision trees; etc.

Machine-learned model 300 may be or include one or more kernel machines. In some implementations, machine-learned model 300 can be or include one or more support vector machines. Machine-learned model 300 may be or include one or more instance-based learning models such as, for example, learning vector quantization models; self-organizing map models; locally weighted learning models; etc. In some implementations, machine-learned model 300 can be or include one or more nearest neighbor models such as, for example, k-nearest neighbor classifications models; k-nearest neighbors regression models; etc. Machine-learned model 300 can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

In some implementations, machine-learned model 300 can be or include one or more artificial neural networks (also referred to simply as neural networks). A neural network can include a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

Machine-learned model 300 can be or include one or more feed forward neural networks. In feed forward networks, the connections between nodes do not form a cycle. For example, each connection can connect a node from an earlier layer to a node from a later layer.

In some instances, machine-learned model 300 can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of the input data sequence to a subsequent portion of the input data sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to-sequence configurations; etc.

In some implementations, machine-learned model 300 can be or include one or more convolutional neural networks. In some instances, a convolutional neural network can include one or more convolutional layers that perform convolutions over input data using learned filters.

Filters can also be referred to as kernels. Convolutional neural networks can be especially useful for vision problems such as when the input data includes imagery such as still images or video. However, convolutional neural networks can also be applied for natural language processing.

In some examples, machine-learned model 300 can be or include one or more generative networks such as, for example, generative adversarial networks. Generative networks can be used to generate new data such as new images or other content.

Machine-learned model 300 may be or include an autoencoder. In some instances, the aim of an autoencoder is to learn a representation (e.g., a lower-dimensional encoding) for a set of data, typically for the purpose of dimensionality reduction. For example, in some instances, an autoencoder can seek to encode the input data and the provide output data that reconstructs the input data from the encoding. Recently, the autoencoder concept has become more widely used for learning generative models of data. In some instances, the autoencoder can include additional losses beyond reconstructing the input data.

Machine-learned model 300 may be or include one or more other forms of artificial neural networks such as, for example, deep Boltzmann machines; deep belief networks; stacked autoencoders; etc. Any of the neural networks described herein can be combined (e.g., stacked) to form more complex networks.

One or more neural networks can be used to provide an embedding based on the input data. For example, the embedding can be a representation of knowledge abstracted from the input data into one or more learned dimensions. In some instances, embeddings can be a useful source for identifying related entities. In some instances, embeddings can be extracted from the output of the network, while in other instances embeddings can be extracted from any hidden node or layer of the network (e.g., a close to final but not final layer of the network). Embeddings can be useful for performing auto suggest next video, product suggestion, entity or object recognition, etc. In some instances, embeddings be useful inputs for downstream models. For example, embeddings can be useful to generalize input data (e.g., search queries) for a downstream model or processing system.

Machine-learned model 300 may include one or more clustering models such as, for example, k-means clustering models; k-medians clustering models; expectation maximization models; hierarchical clustering models; etc.

In some implementations, machine-learned model 300 can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some implementations, machine-learned model 300 can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some implementations, machine-learned model 300 can be an autoregressive model. In some instances, an autoregressive model can specify that the output data depends linearly on its own previous values and on a stochastic term. In some instances, an autoregressive model can take the form of a stochastic difference equation. One example autoregressive model is WaveNet, which is a generative model for raw audio.

In some implementations, machine-learned model 300 can include or form part of a multiple model ensemble. As one example, bootstrap aggregating can be performed, which can also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models can be combined (e.g., through averaging, voting, or other techniques) and used as the output of the ensemble.

One example ensemble is a random forest, which can also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees can be used as the output of the forest. Random decision forests can correct for decision trees' tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of same or different type) can be trained based on training data. In addition, a combiner model can be trained to take the predictions from the other machine-learned models as inputs and, in response, produce a final inference or prediction. In some instances, a single-layer logistic regression model can be used as the combiner model.

Another example ensemble technique is boosting. Boosting can include incrementally building an ensemble by iteratively training weak models and then adding to a final strong model. For example, in some instances, each new model can be trained to emphasize the training examples that previous models misinterpreted (e.g., misclassified). For example, a weight associated with each of such misinterpreted examples can be increased. One common implementation of boosting is AdaBoost, which can also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) can be combined to form an ensemble. As an example, an ensemble can include a top level machine-learned model or a heuristic function to combine and/or weight the outputs of the models that form the ensemble.

In some implementations, multiple machine-learned models (e.g., that form an ensemble can be linked and trained jointly (e.g., through backpropagation of errors sequentially through the model ensemble). However, in some implementations, only a subset (e.g., one) of the jointly trained models is used for inference.

In some implementations, machine-learned model 300 can be used to preprocess the input data for subsequent input into another model. For example, machine-learned model 300 can perform dimensionality reduction techniques and embeddings (e.g., matrix factorization, principal components analysis, singular value decomposition, word2vec/GLOVE, and/or related approaches); clustering; and even classification and regression for downstream consumption. Many of these techniques have been discussed above and will be further discussed below.

As discussed above, machine-learned model 300 can be trained or otherwise configured to receive the input data and, in response, provide the output data. The input data can include different types, forms, or variations of input data. As examples, in various implementations, the input data can include features that describe the content (or portion of content) initially selected by the user, e.g., content of user-selected document or image, links pointing to the user selection, links within the user selection relating to other files available on device or cloud, metadata of user selection, etc. Additionally, with user permission, the input data includes the context of user usage, either obtained from app itself or from other sources. Examples of usage context include breadth of share (sharing publicly, or with a large group, or privately, or a specific person), context of share, etc. When permitted by the user, additional input data can include the state of the device, e.g., the location of the device, the apps running on the device, etc.

In some implementations, machine-learned model 300 can receive and use the input data in its raw form. In some implementations, the raw input data can be preprocessed. Thus, in addition or alternatively to the raw input data, machine-learned model 300 can receive and use the preprocessed input data.

In some implementations, preprocessing the input data can include extracting one or more additional features from the raw input data. For example, feature extraction techniques can be applied to the input data to generate one or more new, additional features. Example feature extraction techniques include edge detection; corner detection; blob detection; ridge detection; scale-invariant feature transform; motion detection; optical flow; Hough transform; etc.

In some implementations, the extracted features can include or be derived from transformations of the input data into other domains and/or dimensions. As an example, the extracted features can include or be derived from transformations of the input data into the frequency domain. For example, wavelet transformations and/or fast Fourier transforms can be performed on the input data to generate additional features.

In some implementations, the extracted features can include statistics calculated from the input data or certain portions or dimensions of the input data. Example statistics include the mode, mean, maximum, minimum, or other metrics of the input data or portions thereof.

In some implementations, as described above, the input data can be sequential in nature. In some instances, the sequential input data can be generated by sampling or otherwise segmenting a stream of input data. As one example, frames can be extracted from a video. In some implementations, sequential data can be made non-sequential through summarization.

As another example preprocessing technique, portions of the input data can be imputed. For example, additional synthetic input data can be generated through interpolation and/or extrapolation.

As another example preprocessing technique, some or all of the input data can be scaled, standardized, normalized, generalized, and/or regularized. Example regularization techniques include ridge regression; least absolute shrinkage and selection operator (LASSO); elastic net; least-angle regression; cross-validation; L1 regularization; L2 regularization; etc. As one example, some or all of the input data can be normalized by subtracting the mean across a given dimension's feature values from each individual feature value and then dividing by the standard deviation or other metric.

As another example preprocessing technique, some or all or the input data can be quantized or discretized. In some cases, qualitative features or variables included in the input data can be converted to quantitative features or variables. For example, one hot encoding can be performed.

In some examples, dimensionality reduction techniques can be applied to the input data prior to input into machine-learned model 300. Several examples of dimensionality reduction techniques are provided above, including, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some implementations, during training, the input data can be intentionally deformed in any number of ways to increase model robustness, generalization, or other qualities. Example techniques to deform the input data include adding noise; changing color, shade, or hue; magnification; segmentation; amplification; etc.

In response to receipt of the input data, machine-learned model 300 can provide the output data. The output data can include different types, forms, or variations of output data. As examples, in various implementations, the output data can include content, either stored locally on the user device or in the cloud, that is relevantly shareable along with the initial content selection.

As discussed above, in some implementations, the output data can include various types of classification data (e.g., binary classification, multiclass classification, single label, multi-label, discrete classification, regressive classification, probabilistic classification, etc.) or can include various types of regressive data (e.g., linear regression, polynomial regression, nonlinear regression, simple regression, multiple regression, etc.). In other instances, the output data can include clustering data, anomaly detection data, recommendation data, or any of the other forms of output data discussed above.

In some implementations, the output data can influence downstream processes or decision making. As one example, in some implementations, the output data can be interpreted and/or acted upon by a rules-based regulator.

The present disclosure provides systems and methods that include or otherwise leverage one or more machine-learned models to suggest content, either stored locally on the uses device or in the cloud, that is relevantly shareable along with the initial content selection based on features of the initial content selection. Any of the different types or forms of input data described above can be combined with any of the different types or forms of machine-learned models described above to provide any of the different types or forms of output data described above.

The systems and methods of the present disclosure can be implemented by or otherwise executed on one or more computing devices. Example computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof.

FIG. 3B illustrates a conceptual diagram of computing device 310, which is an example of computing device 110 of FIG. 1. Computing device 310 includes processing component 302, memory component 304 and machine-learned model 300. Computing device 310 may store and implement machine-learned model 300 locally (i.e., on-device). Thus, in some implementations, machine-learned model 300 can be stored at and/or implemented locally by an embedded device or a user computing device such as a mobile device. Output data obtained through local implementation of machine-learned model 300 at the embedded device or the user computing device can be used to improve performance of the embedded device or the user computing device (e.g., an application implemented by the embedded device or the user computing device).

FIG. 3C illustrates a conceptual diagram of an example client computing device that can communicate over a network with an example server computing system that includes a machine-learned model. FIG. 3C includes client device 310A communicating with server device 360 over network 330. Client device 310A is an example of computing device 110 of FIG. 1, server device 360 is an example of computing system 160 of FIG. 1 and computing system 260 of FIG. 2, and network 330 is an example of network 130 of FIG. 1. Server device 360 stores and implements machine-learned model 300. In some instances, output data obtained through machine-learned model 300 at server device 360 can be used to improve other server tasks or can be used by other non-user devices to improve services performed by or for such other non-user devices. For example, the output data can improve other downstream processes performed by server device 360 for a computing device of a user or embedded computing device. In other instances, output data obtained through implementation of machine-learned model 300 at server device 360 can be sent to and used by a user computing device, an embedded computing device, or some other client device, such as client device 310A. For example, server device 360 can be said to perform machine learning as a service.

In yet other implementations, different respective portions of machine-learned model 300 can be stored at and/or implemented by some combination of a user computing device; an embedded computing device; a server computing device; etc. In other words, portions of machine-learned model 300 may be distributed in whole or in part amongst client device 310A and server device 360.

Devices 310A and 360 may perform graph processing techniques or other machine learning techniques using one or more machine learning platforms, frameworks, and/or libraries, such as, for example, TensorFlow, Caffe/Caffe2, Theano, Torch/PyTorch, MXnet, CNTK, etc. Devices 310A and 360 may be distributed at different physical locations and connected via one or more networks, including network 330. If configured as distributed computing devices, Devices 310A and 360 may operate according to sequential computing architectures, parallel computing architectures, or combinations thereof. In one example, distributed computing devices can be controlled or guided through use of a parameter server.

In some implementations, multiple instances of machine-learned model 300 can be parallelized to provide increased processing throughput. For example, the multiple instances of machine-learned model 300 can be parallelized on a single processing device or computing device or parallelized across multiple processing devices or computing devices.

Each computing device that implements machine-learned model 300 or other aspects of the present disclosure can include a number of hardware components that enable performance of the techniques described herein. For example, each computing device can include one or more memory devices that store some or all of machine-learned model 300. For example, machine-learned model 300 can be a structured numerical representation that is stored in memory. The one or more memory devices can also include instructions for implementing machine-learned model 300 or performing other operations. Example memory devices include RAM, ROM, EEPROM, EPROM, flash memory devices, magnetic disks, etc., and combinations thereof.

Each computing device can also include one or more processing devices that implement some or all of machine-learned model 300 and/or perform other related operations. Example processing devices include one or more of: a central processing unit (CPU); a visual processing unit (VPU); a graphics processing unit (GPU); a tensor processing unit (TPU); a neural processing unit (NPU); a neural processing engine; a core of a CPU, VPU, GPU, TPU, NPU or other processing device; an application specific integrated circuit (ASIC); a field programmable gate array (FPGA); a co-processor; a controller; or combinations of the processing devices described above. Processing devices can be embedded within other hardware components such as, for example, an image sensor, accelerometer, etc.

Hardware components (e.g., memory devices and/or processing devices) can be spread across multiple physically distributed computing devices and/or virtually distributed computing systems.

FIG. 3D illustrates a conceptual diagram of an example computing device in communication with an example training computing system that includes a model trainer. FIG. 3D includes client device 310B communicating with training device 370 over network 330. Client device 310B is an example of computing device 110 of FIG. 1 and network 330 is an example of network 130 of FIG. 1. Machine-learned model 300 described herein can be trained at a training computing system, such as training device 370, and then provided for storage and/or implementation at one or more computing devices, such as client device 310B. For example, model trainer 372 executes locally at training device 370. However in some examples, training device 370, including model trainer 372, can be included in or separate from client device 310B or any other computing device that implement machine-learned model 300.

In some implementations, machine-learned model 300 may be trained in an offline fashion or an online fashion. In offline training (also known as batch learning), machine-learned model 300 is trained on the entirety of a static set of training data. In online learning, machine-learned model 300 is continuously trained (or re-trained) as new training data becomes available (e.g., while the model is used to perform inference).

Model trainer 372 may perform centralized training of machine-learned model 300 (e.g., based on a centrally stored dataset). In other implementations, decentralized training techniques such as distributed training, federated learning, or the like can be used to train, update, or personalize machine-learned model 300.

Machine-learned model 300 described herein can be trained according to one or more of various different training types or techniques. For example, in some implementations, machine-learned model 300 can be trained by model trainer 372 using supervised learning, in which machine-learned model 300 is trained on a training dataset that includes instances or examples that have labels. The labels can be manually applied by experts, generated through crowd-sourcing, or provided by other techniques (e.g., by physics-based or complex mathematical models). In some implementations, if the user has provided consent, the training examples can be provided by the user computing device. In some implementations, this process can be referred to as personalizing the model.

FIG. 3E illustrates a conceptual diagram of training process 390 which is an example training process in which machine-learned model 300 is trained on training data 391 that includes example input data 392 that has labels 393. Training processes 390 is one example training process; other training processes may be used as well.

Training data 391 used by training process 390 can include, upon user permission for use of such data for training, anonymized usage logs of sharing flows, e.g., content items that were shared together, bundled content pieces already identified as belonging together, e.g., from entities in a knowledge graph, etc. In some implementations, training data 391 can include examples of input data 392 that have been assigned labels 393 that correspond to output data 394.

In some implementations, machine-learned model 300 can be trained by optimizing an objective function, such as objective function 395. For example, in some implementations, objective function 395 may be or include a loss function that compares (e.g., determines a difference between) output data generated by the model from the training data and labels (e.g., ground-truth labels) associated with the training data. For example, the loss function can evaluate a sum or mean of squared differences between the output data and the labels. In some examples, objective function 395 may be or include a cost function that describes a cost of a certain outcome or output data. Other examples of objective function 395 can include margin-based techniques such as, for example, triplet loss or maximum-margin training.

One or more of various optimization techniques can be performed to optimize objective function 395. For example, the optimization technique(s) can minimize or maximize objective function 395. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some implementations, backward propagation of errors can be used in conjunction with an optimization technique (e.g., gradient based techniques) to train machine-learned model 300 (e.g., when machine-learned model is a multi-layer model such as an artificial neural network). For example, an iterative cycle of propagation and model parameter (e.g., weights) update can be performed to train machine-learned model 300. Example backpropagation techniques include truncated backpropagation through time, Levenberg-Marquardt backpropagation, etc.

In some implementations, machine-learned model 300 described herein can be trained using unsupervised learning techniques. Unsupervised learning can include inferring a function to describe hidden structure from unlabeled data. For example, a classification or categorization may not be included in the data. Unsupervised learning techniques can be used to produce machine-learned models capable of performing clustering, anomaly detection, learning latent variable models, or other tasks.

Machine-learned model 300 can be trained using semi-supervised techniques which combine aspects of supervised learning and unsupervised learning. Machine-learned model 300 can be trained or otherwise generated through evolutionary techniques or genetic algorithms. In some implementations, machine-learned model 300 described herein can be trained using reinforcement learning. In reinforcement learning, an agent (e.g., model) can take actions in an environment and learn to maximize rewards and/or minimize penalties that result from such actions. Reinforcement learning can differ from the supervised learning problem in that correct input/output pairs are not presented, nor sub-optimal actions explicitly corrected.

In some implementations, one or more generalization techniques can be performed during training to improve the generalization of machine-learned model 300. Generalization techniques can help reduce overfitting of machine-learned model 300 to the training data. Example generalization techniques include dropout techniques; weight decay techniques; batch normalization; early stopping; subset selection; stepwise selection; etc.

In some implementations, machine-learned model 300 described herein can include or otherwise be impacted by a number of hyperparameters, such as, for example, learning rate, number of layers, number of nodes in each layer, number of leaves in a tree, number of clusters; etc. Hyperparameters can affect model performance. Hyperparameters can be hand selected or can be automatically selected through application of techniques such as, for example, grid search; black box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some implementations, various techniques can be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some implementations, transfer learning techniques can be used to provide an initial model from which to begin training of machine-learned model 300 described herein.

In some implementations, machine-learned model 300 described herein can be included in different portions of computer-readable code on a computing device. In one example, machine-learned model 300 can be included in a particular application or program and used (e.g., exclusively) by such particular application or program. Thus, in one example, a computing device can include a number of applications and one or more of such applications can contain its own respective machine learning library and machine-learned model(s).

In another example, machine-learned model 300 described herein can be included in an operating system of a computing device (e.g., in a central intelligence layer of an operating system) and can be called or otherwise used by one or more applications that interact with the operating system. In some implementations, each application can communicate with the central intelligence layer (and model(s) stored therein) using an application programming interface (API) (e.g., a common, public API across all applications).

In some implementations, the central intelligence layer can communicate with a central device data layer. The central device data layer can be a centralized repository of data for the computing device. The central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination.

Databases and applications can be implemented on a single system or distributed across multiple systems. Distributed components can operate sequentially or in parallel.

In addition, the machine learning techniques described herein are readily interchangeable and combinable. Although certain example techniques have been described, many others exist and can be used in conjunction with aspects of the present disclosure.

A brief overview of example machine-learned models and associated techniques has been provided by the present disclosure. For additional details, readers should review the following references: Machine Learning A Probabilistic Perspective (Murphy); Rules of Machine Learning: Best Practices for ML Engineering (Zinkevich); Deep Learning (Goodfellow); Reinforcement Learning: An Introduction (Sutton); and Artificial Intelligence: A Modern Approach (Norvig).

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

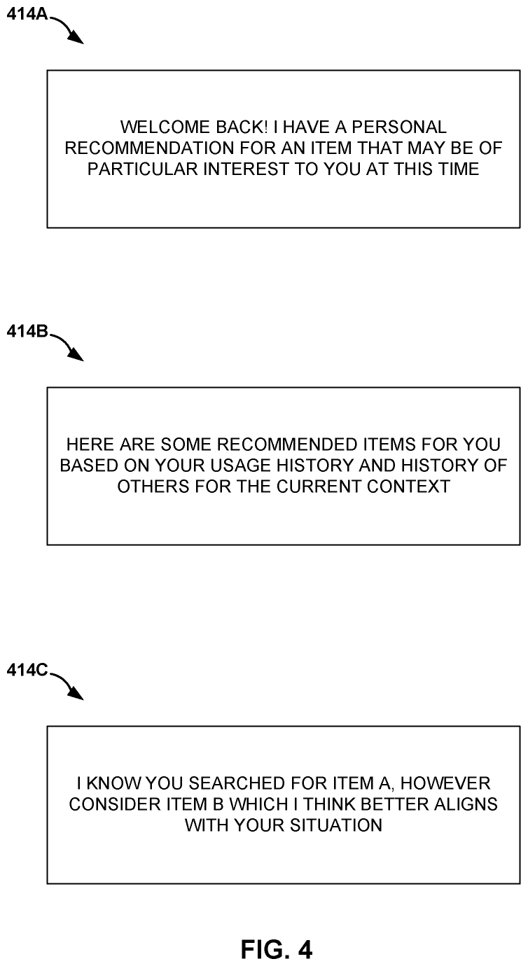

FIG. 4 is a conceptual diagram illustrating example indications of recommendations that are output by a computing device that accesses a computing system that relies on sequence modelling to account for temporal and/or sequential differences in user behavior when making predictions about future user interactions with the computing system, in accordance with one or more aspects of the present disclosure. FIG. 4 is described in the context of user interface 114 of system 100 of FIG. 1.

User interfaces 414A through 414C are some examples of user interface 114, many other examples exist. Computing system 160 may cause computing device 110 to present any of user interfaces 414A through 414C at UIC 112 when application provider client module 120 requests access to the application provider service provided by application provider service module 162. Although shown as simple textual interfaces, in other examples, user interfaces 414A through 414C may be part of an audible interface, graphical user interface, haptic user interface, or any combination thereof.

User interface 414A includes information indicative of a recommendation for a particular item that may interest a user of computing device 110, given a current context. User interface 414A may include a highest-ranking item (e.g., application) from the service provided by computing system 160, given the sequence output provided from sequence model 165 to prediction model 166, which is based on features extracted from contextual information associated with computing device 110 (e.g., by feature module 163).

User interface 414B includes information indicative of a recommendation for multiple particular items that may interest a user of computing device 110, given a current context and usage history of the user as well as other users of computing system 160. User interface 414B may include one or more highest-ranked items (e.g., applications) from the service provided by computing system 160, given the sequence output provided from sequence model 165 to prediction model 166, which is based on features extracted from: contextual information associated with computing device 110 (e.g., by feature module 163) as well as contextual information associated with other computing devices. That is, user interface 414B shows how computing system 160, and the models 165 and 166 that execute thereon, may use crowd-sourcing to generate rules and learn not only from behaviors of users of computing device 110, but also from behaviors of other users of other computing devices.

User interface 414C includes information indicative of a recommendation for a particular item that may interest a user of computing device 110, given a current search context and usage history of the user. For example, a search component of application provider service module 162 may execute a user query for a particular application. The search may return one or more results. Rather than output the results as-is, application provider service module 162 may query prediction model 166 for a recommendation. In some examples, the user query may form one or more feature embeddings inputted into prediction model 166 to provide the recommendation.

In any event, application provider service module 162 may obtain a recommendation from prediction model 166 that ranks a different application higher than the one that the user may have been searching, for a current context. User interface 414C may include the different application as a recommendation in addition to, or in lieu of the search results.

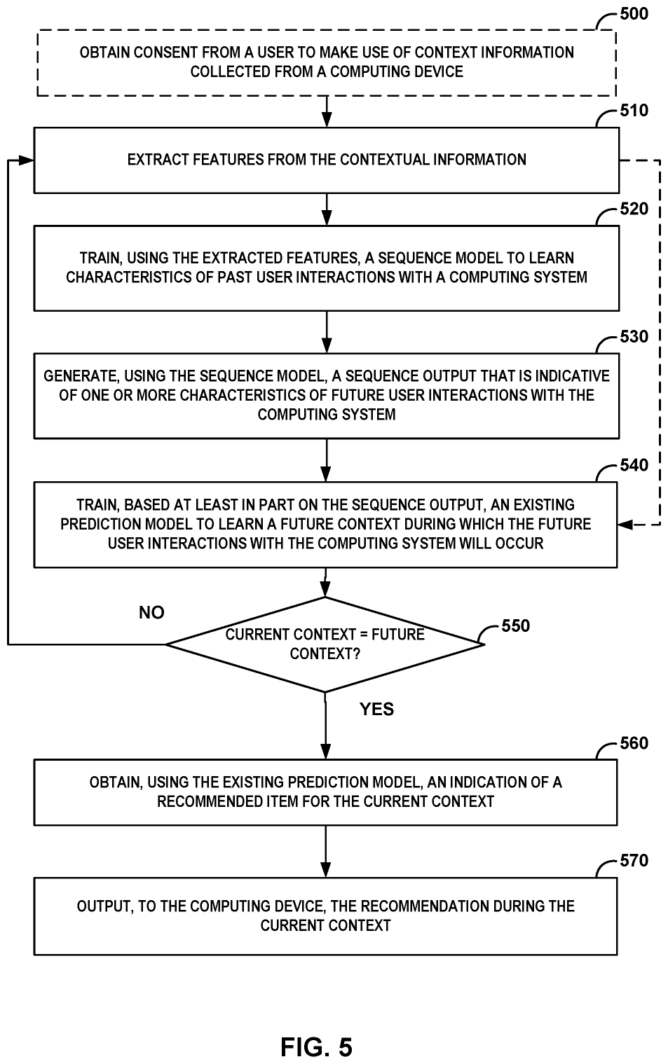

FIG. 5 is a flowchart illustrating example operations performed by an example computing system that relies on sequence modelling to account for temporal and/or sequential differences in user behavior when making predictions about future user interactions with the computing system, in accordance with one or more aspects of the present disclosure. Operations 500-570 may be performed by a computing system, such as computing systems 160, 260. In some examples, a computing system may perform operations 500-570 in a different order than that shown in FIG. 5. In some examples, a computing system may perform additional or fewer operations than operations 500-570. For ease of description, FIG. 5 is described in the context of computing system 260 of FIG. 2.

As shown in FIG. 5, in operation, computing system 260 may obtain consent from user to make use of contextual information associated with the user and/or computing device 110 (500). For example, before computing system 260 or computing device 110 stores or transmits contextual information, a user of computing device 110 will be offered an opportunity to give or not give computing system 260 permission to collect and make use of such data. Only if a user clearly and unambiguously consents to such data collection will computing system 260 make use of application performance data from the user's device.

Computing system 260 may extract features from the contextual information (510). For example, feature module 263 may obtain contextual information from computing device 110 as a user accesses a service provided by service module 262. Feature module 263 may store the extracted features at context data store 267.

Computing system 260 may train, using features extracted from the contextual information, a sequence model to determine characteristics of past user interactions with the service provided by service module 262 (520). For example, using an attention model, sequence model 265 may correlate extracted temporal or sequential features with items in items data store 264. That is, training module 268 may cause sequence model 265 may receive as input, overtime, an indication of temporal or sequential features associated with a context during which each item from item data store 264 was previously retrieved. Training module 268 may cause sequence model 265 to learn what temporal or sequential features correlate with what items.

Computing system 260 may generate, using the sequence model, a sequence output that is indicative of one or more characteristics of future user interactions with computing system 260 (530). For example, after being trained, sequence model 265 may output a sequence embedding for each of the different items in items data store 264 that is indicative of the temporal or sequential characteristics of future behavior that indicate a context that would be particularly relevant to that item.

Computing system 260 may train, based at least in part on the sequence output, an existing prediction model to learn a future context during which future user interactions with particular items from items data store 264 will occur (540). For example, training module 268 may cause prediction model 266 to learn from the output of model 265 how to embed the items stored at items data store 264 with (temporal, non-temporal, sequential, and/or non-sequential) feature embeddings that are indicative of future contexts when retrieval of the items is likely to occur. As such, prediction model 266, which is an existing prediction model having previously been trained by other, non-temporal or non-sequential, characteristics of user behavior, is adapted for use with sequence model 265 and trained by training model 268, to better model and predict future behavior with items that will coincide with previously observed temporal or sequential behaviors with computing system 260.

In some examples, feature module 263 generates feature embeddings that are indicative of non-temporal or non-sequential characteristics of future user interactions with items from items data store 264 that will result in the conversion of the items from the service of service module 262. For example, feature module 263 may extract things like, item name, item location, item category, item genre, or any other non-temporal or non-sequential feature. Training module 268 may train prediction model 266, based at least in part on a sequence embedding output from sequence model 265 and the one or more other feature embeddings, to identify a future context during which future user interactions with the service result in the conversion of a particular item, from the service.

After having been trained to identify which items are likely to be retrieved from computing system 260 given a particular future context, prediction model 266 may determine whether a current context corresponds to that particular future context (550). For example, prediction model 266 may receive as input various feature embeddings extracted from contextual information of computing device 110, at a current time. Sequence model 265 may concurrently receive one or more of the feature embeddings extracted from the contextual information and generate a sequence output. Prediction model 266 may use the sequence output from sequence model 265, along with the extracted features from feature module 263 that are indicative of a current context, to determine one or more item recommendations that service module 262 may present to a user. For example, prediction model 266 may obtain from item data store 264, one or more items that have feature embeddings that correspond to the feature embeddings of the current context (550).

Computing system 260 may output, to computing device 110, the recommendation during the current context (560). For example, service module 262 may modify, based on a recommendation from prediction model 266, a user interface of the service being accessed by computing device 110 such that the item(s) of the recommendation from model 266 are presented (e.g., audibly, visually, in haptic form) more prominently in the user interface than one or more other available items from the service managed by service module 262.

By enabling computing systems to more easily account for temporal or sequential differences in user behavior, the described techniques may improve the accuracy of existing prediction models, without requiring much if any re-engineering of the existing prediction models, to account for such differences. That is, an existing prediction or ranking system may already rely on other, pre-existing feature embeddings for making predictions about items in a prediction space. In a similar way, these existing systems can easily be reconfigured to also rely on all new sequence embeddings that are indicative of the temporal or sequential aspects of user behavior with the items. Accordingly, by accounting for temporal or sequential differences in user behavior, an example computing system may perform better, operate more efficiently, and perhaps result in a more useful user experience. The example computing system may therefore minimize frustrations users may otherwise experience from interactions with a less accurate prediction or ranking system.

Clause 1. A method comprising: training, using features extracted from contextual information of a computing device, a sequence model to determine characteristics of past user interactions with an application provider service that resulted in conversions from the application provider service; generating, by a computing system, using the sequence model, a sequence output that is indicative of one or more characteristics of future user interactions with the application provider service that will result in a conversion of a particular application from the application provider service; training, based at least in part on the sequence output, an existing prediction model to identify a future context during which the future user interactions with the application provider service result in the conversion of the particular application from the application provider service; responsive to inputting, by the computing system, into the prediction model, a current context of the computing device that corresponds to the future context: obtaining, from the existing prediction model, an indication of the particular application; and modifying, by the computing system, based on the indication of the particular application, a user interface of the application provider service being accessed by the computing device such that the particular application is presented more prominently in the user interface than one or more other applications from the application provider service.

Clause 2. The method of clause 1, wherein the sequence output comprises a sequence embedding, the method further comprising: generating one or more other feature embeddings that are indicative of non-temporal or non-sequential characteristics of the future user interactions with the application provider service that will result in the conversion of the particular application from the application provider service; and training, based at least in part on the sequence embedding and the one or more other feature embeddings, the existing prediction model to identify the future context during which the future user interactions with the application provider service result in the conversion of the particular application from the application provider service.

Clause 3. The method of clause 2, wherein: the sequence embedding is a coded combination of multiple characteristics of the future user interactions with the application provider service that will result in the conversion of the particular application from the application provider service; or the sequence embedding is a coded combination of a single characteristic of the future user interactions with the application provider service that will result in the conversion of the particular application from the application provider service.

Clause 4. The method of any of clauses 1-3, wherein the sequence output comprises one or more latent crosses between primary and auxiliary feature embeddings of the features extracted from the contextual information associated with the computing device, the method further comprising: the one or more latent crosses are used by the existing prediction model to account for the characteristics of the future user interactions with the application provider service that will result in the conversion of the particular application from the application provider service; and training, based at least in part on the one or more latent crosses and one or more other feature embeddings derived from the features extracted from the contextual information associated with the computing device, the existing prediction model to identify the future context during which the future user interactions with the application provider service result in the conversion of the particular application from the application provider service.

Clause 5. The method of any of clauses 1-4, wherein generating the sequence output using the sequence model comprises generating, based on primary and auxiliary feature embeddings of the features extracted from contextual information associated with the computing device, one or more sequence embeddings that capture the characteristics of the future user interactions with the application provider service that will result in the conversion of the particular application from the application provider service.

Clause 6. The method of any of clauses 1-4, wherein generating the sequence output using the sequence model comprises generating one or more latent crosses between primary and auxiliary feature embeddings of the features extracted from contextual information associated with the computing device, wherein the one or more latent crosses are used by the existing prediction model to account for the characteristics of the future user interactions with the application provider service that will result in the conversion of the particular application from the application provider service.

Clause 7. The method of any of clauses 1-6, wherein the conversions from the application provider service comprise application downloads from the application provider service.

Clause 8. The method of any of clauses 1-7, wherein the sequence model comprises a combination of one or more attention models, long short term memory models, and recurring neural network models.

Clause 9. The method of any of clauses 1-8, wherein the existing prediction model comprises a deep neural network model configured to receive the sequence output from the sequence model.

Clause 10. A computing system comprising at least one processor configured to perform any of the methods of clauses 1-9.

Clause 11. A computing system comprising means for performing any of the methods of clauses 1-9.

Clause 12. A computer-readable storage medium comprising instructions that, when executed, cause at least one processor to perform any of the methods of clauses 1-9.

By way of example, and not limitation, such computer-readable storage media can comprise RAM, ROM, EEPROM, CD-ROM or other optical disk storage, magnetic disk storage, or other magnetic storage devices, flash memory, or any other storage medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage mediums and media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable medium.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various embodiments have been described. These and other embodiments are within the scope of the following claims.

1: A method comprising:
training, using features extracted from contextual information of a computing device, a sequence model to determine characteristics of past user interactions with an application provider service that resulted in conversions from the application provider service;
generating, by a computing system, using the sequence model, a sequence output that is indicative of one or more characteristics of future user interactions with the application provider service that will result in a conversion of a particular application from the application provider service;
training, based at least in part on the sequence output, an existing prediction model to identify a future context during which the future user interactions with the application provider service result in the conversion of the particular application from the application provider service;
responsive to inputting, by the computing system, into the prediction model, a current context of the computing device that corresponds to the future context:
obtaining, from the existing prediction model, an indication of the particular application; and
modifying, by the computing system, based on the indication of the particular application, a user interface of the application provider service being accessed by the computing device such that the particular application is presented more prominently in the user interface than one or more other applications from the application provider service.

2: The method of claim 1, wherein the sequence output comprises a sequence embedding, the method further comprising:
generating one or more other feature embeddings that are indicative of non-temporal or non-sequential characteristics of the future user interactions with the application provider service that will result in the conversion of the particular application from the application provider service; and
training, based at least in part on the sequence embedding and the one or more other feature embeddings, the existing prediction model to identify the future context during which the future user interactions with the application provider service result in the conversion of the particular application from the application provider service.

3: The method of claim 2, wherein:
the sequence embedding is a coded combination of multiple characteristics of the future user interactions with the application provider service that will result in the conversion of the particular application from the application provider service; or
the sequence embedding is a coded combination of a single characteristic of the future user interactions with the application provider service that will result in the conversion of the particular application from the application provider service.

4: The method of claim 1, wherein the sequence output comprises one or more latent crosses between primary and auxiliary feature embeddings of the features extracted from the contextual information associated with the computing device, the method further comprising:
the one or more latent crosses are used by the existing prediction model to account for the characteristics of the future user interactions with the application provider service that will result in the conversion of the particular application from the application provider service; and
training, based at least in part on the one or more latent crosses and one or more other feature embeddings derived from the features extracted from the contextual information associated with the computing device, the existing prediction model to identify the future context during which the future user interactions with the application provider service result in the conversion of the particular application from the application provider service.

5: The method of claim 1, wherein generating the sequence output using the sequence model comprises generating, based on primary and auxiliary feature embeddings of the features extracted from contextual information associated with the computing device, one or more sequence embeddings that capture the characteristics of the future user interactions with the application provider service that will result in the conversion of the particular application from the application provider service.

6: The method of claim 1, wherein generating the sequence output using the sequence model comprises generating one or more latent crosses between primary and auxiliary feature embeddings of the features extracted from contextual information associated with the computing device, wherein the one or more latent crosses are used by the existing prediction model to account for the characteristics of the future user interactions with the application provider service that will result in the conversion of the particular application from the application provider service.

7: The method of claim 1, wherein the conversions from the application provider service comprise application downloads from the application provider service.

8: The method of claim 1, wherein the sequence model comprises a combination of attention models, long short-term memory models, and recurring neural network models.

9: The method of claim 1, wherein the existing prediction model comprises a deep neural network model configured to receive the sequence output from the sequence model.

10: A computing system comprising:
at least one processor configured to:
train, using features extracted from contextual information of a computing device, a sequence model to determine characteristics of past user interactions with an application provider service that resulted in conversions from the application provider service;
generate, using the sequence model, a sequence output that is indicative of one or more characteristics of future user interactions with the application provider service that will result in a conversion of a particular application from the application provider service;
train, based at least in part on the sequence output, an existing prediction model to identify a future context during which the future user interactions with the application provider service result in the conversion of the particular application from the application provider service;
responsive to inputting into the prediction model, a current context of the computing device that corresponds to the future context:
obtain, from the existing prediction model, an indication of the particular application; and
modify, based on the indication of the particular application, a user interface of the application provider service being accessed by the computing device such that the particular application is presented more prominently in the user interface than one or more other applications from the application provider service; and
a memory configured to store the prediction model.

11. (canceled)

12: A computer-readable storage medium comprising instructions that, when executed, cause at least one processor to:
train, using features extracted from contextual information of a computing device, a sequence model to determine characteristics of past user interactions with an application provider service that resulted in conversions from the application provider service;
generate, using the sequence model, a sequence output that is indicative of one or more characteristics of future user interactions with the application provider service that will result in a conversion of a particular application from the application provider service;
train, based at least in part on the sequence output, an existing prediction model to identify a future context during which the future user interactions with the application provider service result in the conversion of the particular application from the application provider service;
responsive to inputting into the prediction model, a current context of the computing device that corresponds to the future context:
obtain, from the existing prediction model, an indication of the particular application; and modify, based on the indication of the particular application, a user interface of the application provider service being accessed by the computing device such that the particular application is presented more prominently in the user interface than one or more other applications from the application provider service.

13: The computing system of claim 10, wherein the sequence output comprises a sequence embedding, the at least one processor further configured to:
generate one or more other feature embeddings that are indicative of non-temporal or non-sequential characteristics of the future user interactions with the application provider service that will result in the conversion of the particular application from the application provider service; and
train, based at least in part on the sequence embedding and the one or more other feature embeddings, the existing prediction model to identify the future context during which the future user interactions with the application provider service result in the conversion of the particular application from the application provider service.

14: The computing system of claim 13, wherein:
the sequence embedding is a coded combination of multiple characteristics of the future user interactions with the application provider service that will result in the conversion of the particular application from the application provider service; or
the sequence embedding is a coded combination of a single characteristic of the future user interactions with the application provider service that will result in the conversion of the particular application from the application provider service.

15: The computing system of claim 10, wherein the sequence output comprises one or more latent crosses between primary and auxiliary feature embeddings of the features extracted from the contextual information associated with the computing device, the at least one processor further configured to:
use the one or more latent crosses by the existing prediction model to account for the characteristics of the future user interactions with the application provider service that will result in the conversion of the particular application from the application provider service; and
train, based at least in part on the one or more latent crosses and one or more other feature embeddings derived from the features extracted from the contextual information associated with the computing device, the existing prediction model to identify the future context during which the future user interactions with the application provider service result in the conversion of the particular application from the application provider service.

16: The computing system of claim 10, wherein the at least one processor are configured to generate, based on primary and auxiliary feature embeddings of the features extracted from contextual information associated with the computing device, one or more sequence embeddings that capture the characteristics of the future user interactions with the application provider service that will result in the conversion of the particular application from the application provider service.

17: The computing system of claim 10, wherein the at least one processor are configured to generate one or more latent crosses between primary and auxiliary feature embeddings of the features extracted from contextual information associated with the computing device, wherein the one or more latent crosses are used by the existing prediction model to account for the characteristics of the future user interactions with the application provider service that will result in the conversion of the particular application from the application provider service.

18: The computing system of claim 10, wherein the conversions from the application provider service comprise application downloads from the application provider service.

19: The computing system of claim 10, wherein the sequence model comprises a combination of attention models, long short-term memory models, and recurring neural network models.

20: The computing system of claim 10, wherein the existing prediction model comprises a deep neural network model configured to receive the sequence output from the sequence model.

21: The computer-readable storage medium of claim 12,
wherein the sequence output comprises a sequence embedding,
wherein the instructions, when executed by the at least one processor, further cause the at least one processor to:
generate one or more other feature embeddings that are indicative of non-temporal or non-sequential characteristics of the future user interactions with the application provider service that will result in the conversion of the particular application from the application provider service; and
train, based at least in part on the sequence embedding and the one or more other feature embeddings, the existing prediction model to identify the future context during which the future user interactions with the application provider service result in the conversion of the particular application from the application provider service.
